(19) United States
(12) Patent Application Publication
(10) Pub. No.: US 2008/0031010 A1
(43) Pub. Date: Feb. 7, 2008

(54) BACKLIGHT UNIT AND LIQUID CRYSTAL DISPLAY HAVING THE SAME

(76) Inventors: Jeung Soo Kim, Seoul (KR); Young Bee Chu, Suwon-Si (KR); Ik Soo Lee, Seoul (KR); Kyu Seok Kim, Yongin-Si (KR); Tae Joon Kim, Seongnam-Si (KR); Jeong Seok Oh, Seoul (KR); Sung Min Kim, Yongin-Si (KR); Young Hee Park, Busan (KR)

Correspondence Address: MACPHERSON KWOK CHEN & HEID LLP, 2033 GATEWAY PLACE, SUITE 400, SAN JOSE, CA, 95110, US

(21) Appl. No.: 11/833,792

(22) Filed: Aug. 3, 2007

(30) Foreign Application Priority Data
Aug. 7, 2006 (KR) 10-2006-0074222

(51) Int. Cl. F21V 8/00

(52) U.S. Cl. 362/612

(57) ABSTRACT

According to an embodiment of the present invention, a backlight unit may include a light guide plate having a groove with a first shape formed in at least one side thereof, at least one light emitting diode (LED) having a projected lens, the LED being arranged in correspondence to the grove of the light guide plate, a first reflection plate arranged over the LED, and a second reflection plate arranged below the LED.

### CROSS-REFERENCE TO RELATED APPLICATION

This application claims priority to and the benefit of Patent Application No. 10-2006-0074222 filed in the Korean Intellectual Property Office, Republic of Korea, on Aug. 7, 2006, the entire content of which is incorporated by reference.

### BACKGROUND

1. Field of Invention

The present invention relates to a display devices, and more particularly to a backlight unit and a liquid crystal display having the same.

2. Description of the Prior Art

A liquid crystal display (LCD) has many advantages, including small size, a thin profile, light weight, and a relatively large viewing area in comparison with a conventional cathode ray tube (CRT), so LCD development has become an active are of interest. In addition, the LCD may be used in various fields and applications (i.e. computer monitors and large display devices). A typical LCD modulates light transmissivity according to image signals applied to a plurality of control switches arranged in a matrix form to display a desired image on an LCD screen. The LCD includes an LCD panel for substantially displaying an image, a driving integrated circuit (IC) for operating the LCD panel, a backlight unit used as a light source of the LCD panel, and chassis for integrating the above components of the LCD.

For a small-sized LCD, such as one generally used in a mobile communication terminal, a side-view LED is typically used as a light source of a backlight unit. However, since the side-view LED typically has a small light output angle, there is a problem in that a greater number of LEDs are typically required for uniformly illuminating the entire light guide plate. Accordingly, there has been proposed a structure in which an LED with a lens configured to have a large light output angle is used as a light source and the lens of such an LED is inserted into an incident portion of the light guide plate. However, there are problems in that this LED does not ensure reliability in spite of its improved light output angle since the exposed lens is sensitive to temperature and moisture, and the LCD panel may have an unsightly appearance.

### SUMMARY

Embodiments of the present invention are conceived to solve the aforementioned problems and others in the prior art. An object of one or more embodiments is to provide a backlight unit having a structure capable of minimizing an optical loss of an LCD using an LED with a projected lens as a light source, and an LCD having such a backlight unit. Another object of one or more embodiments is to provide a backlight unit ensuring reliability and having an improved external appearance, and an LCD having such a backlight unit.

According to an embodiment of the present invention, a backlight unit may include a light guide plate having a groove with a first shape formed in at least one side thereof; at least one light emitting diode (LED) having a projected lens, the LED being arranged in correspondence to the groove of the light guide plate; a first reflection plate arranged over the LED; and a second reflection plate arranged below the LED.

The backlight unit may further comprise a flexible printed circuit board (FPCB) for mounting the LED thereon, wherein the first reflection plate is arranged on the FPCB to cover a portion of an upper surface of the light guide plate and an upper surface of the lens of the LED. The first reflection plate may include white polyethylene terephthalate (PET). The second reflection plate may be arranged below the light guide plate, and at least one end of the second reflection plate may extend to the LED. The backlight unit may further comprise a plurality of optical sheets arranged over the light guide plate, wherein a light blocking layer configured to block light emitted from the LED is formed on at least one end of at least one of the plurality of optical sheets. The plurality of optical sheets may include a diffusion plate arranged on the light guide plate, and at least one prism sheet arranged on the diffusion plate, wherein the light blocking layer is formed on at least one end of the diffusion plate. The light blocking layer and the first reflection plate may be partially overlapped with each other. The backlight unit may further comprise a pressing member arranged on the first reflection plate, the pressing member being configured to press against the first reflection plate. The LED may include a substrate, at least one LED chip mounted on the substrate, and a LED lens encapsulating the LED chip, wherein the LED lens comprises a base formed on the substrate, the LED lens including a protrusion formed to protrude from the base in a second shape. The first shape groove of the light guide plate may be adapted to mate with the second shape protrusion of the LED lens. The first shape may be a semicircular groove and the second shape may be a corresponding semicircular protrusion.

According to another embodiment, a liquid crystal display (LCD) may include a backlight unit comprising a light guide plate having a groove with a first shape formed in at least one side thereof; at least one light emitting diode (LED) having a projected lens, the LED being arranged in correspondence to the groove of the light guide plate; a first reflection plate arranged adjacent to an LED first surface; and a second reflection plate arranged adjacent to an LED second surface, the second surface being substantially parallel to the first surface.

The backlight unit of the LCD may further include a flexible printed circuit board (FPCB) for mounting the LED thereon, wherein the first reflection plate is arranged on the FPCB to cover a portion of an upper surface of the light guide plate and an upper surface of the lens of the LED. The first reflection plate may includes white polyethylene terephthalate (PET). The second reflection plate may be arranged below the light guide plate, and at least one end of the second reflection plate extends to the LED. The backlight unit may further comprise a plurality of optical sheets arranged over the light guide plate, wherein a light blocking layer configured to block light emitted from the LED is formed on at least one end of at least one of the plurality of optical sheets. The plurality of optical sheets may include a diffusion plate arranged on the light guide plate, and at least one prism sheet arranged on the diffusion plate, wherein the light blocking layer is formed on at least one end of the diffusion plate. The light blocking layer and the first reflection plate may be partially overlapped with each other. The backlight unit may further comprise a pressing member arranged on the first reflection plate, the pressing member being configured to press against the first reflection plate. The LED may include a substrate, at least one LED chip mounted on the substrate, and a LED lens encapsulating the LED chip, wherein the LED lens comprises a base formed on the substrate, the LED lens including a protrusion formed to protrude from the base in a second shape, the first shape groove of the light guide plate being adapted to mate with the second shape protrusion of the LED lens, the first shape being a semicircular groove and the second shape being a corresponding semicircular protrusion.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a partial exploded perspective view showing a backlight unit according to a first embodiment of the present invention;

FIGS. 2A and 2B are a perspective view and a sectional view showing an LED (Light Emitting Diode) of the backlight unit shown in FIG. 1;

FIG. 2C is a schematic perspective view showing a light guide plate to which the LED is installed;

FIG. 3 is a schematic sectional view showing the backlight unit of FIG. 1;

FIGS. 4A and 4B are a partial exploded perspective view and a sectional view showing a backlight unit according to a second embodiment of the present invention;

FIGS. 5A and 5B are a partial exploded perspective view and a sectional view showing a backlight unit according to a third embodiment of the present invention; and

FIG. 6 is an exploded perspective view showing a light crystal display having the backlight unit according to an embodiment of the present invention.

### DETAILED DESCRIPTION

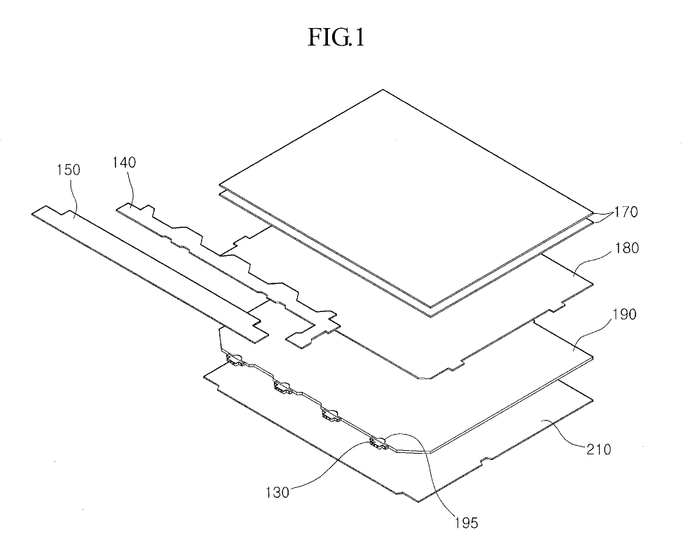

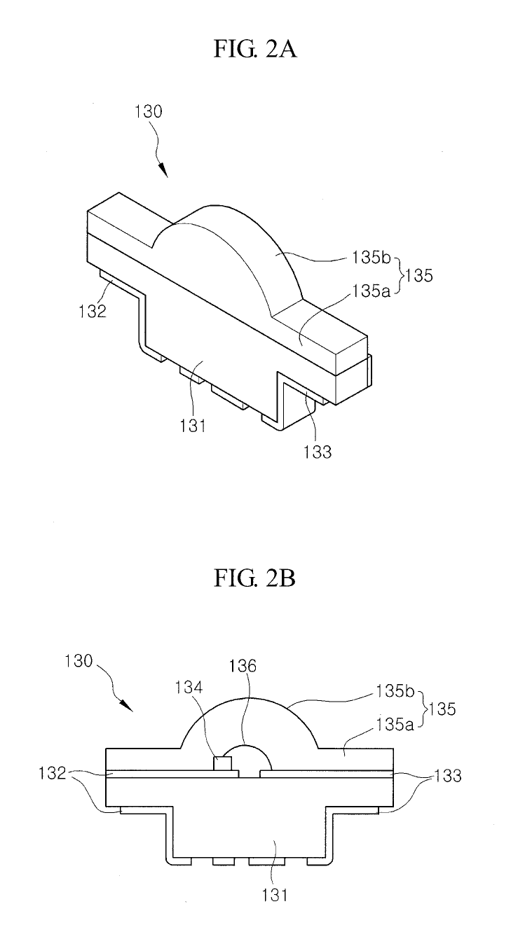

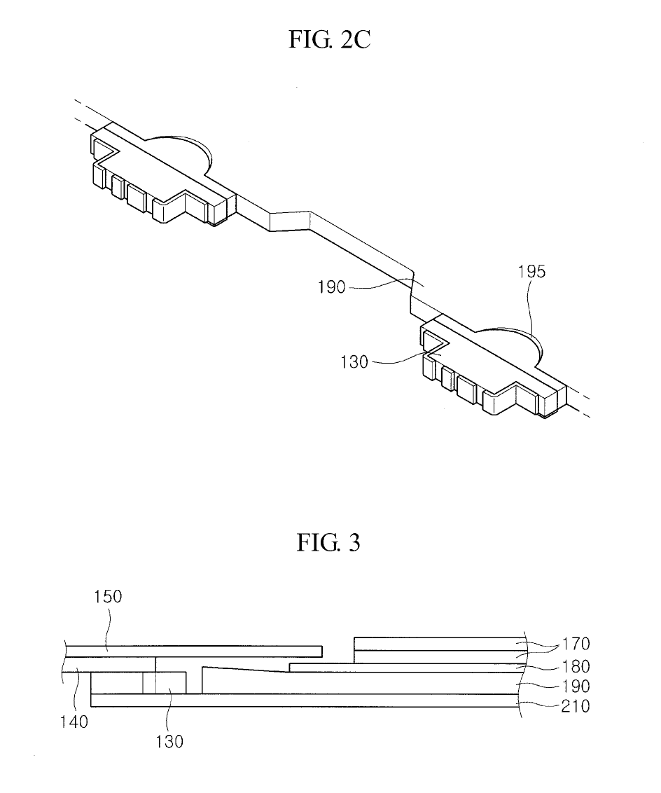

Preferred embodiments of the present invention will be described in detail with reference to one or more of the accompanying drawings. FIG. 1 is a partial exploded perspective view showing a backlight unit according to the first embodiment of the present invention, FIGS. 2A and 2B are a perspective view and a sectional view showing an LED (Light Emitting Diode) of the backlight unit shown in FIG. 1, FIG. 2C is a schematic perspective view showing a light guide plate to which the LED is installed, and FIG. 3 is a schematic sectional view showing the backlight unit of FIG. 1. Referring to FIGS. 1 and 3, the backlight unit according to the first embodiment of the present invention includes LEDs 130, an LED flexible printed circuit board (FPCB) 140, a first reflection plate 150, a plurality of optical sheets 170 and 180, a light guide plate 190 and a second reflection plate 210. In this disclosure, words such as over, under, above, below, right, left, back, and front, may be used to describe the relative position of an element or group of elements in relation to one or more other elements. It is understood that such relative description words may be changed based on the orientation of the referenced elements or system, including the case where a first element is referenced as above one element and then referenced as below that same element if the system is turned upside-down, for example.

One or more LEDs 130 may be used as a light source for the backlight unit according to embodiments of the present invention. These LEDs generate a white light by coupling phosphor on blue or ultraviolet (UV) LED chips, or combining two or three LED chips emitting Tights of different frequencies into a multi-chip form. In this embodiment, as the LED 130, an LED with a lens is used instead of a conventional side-view LED. The LED with a lens has a larger light output angle and improved brightness in comparison to the conventional side-view LED.

Referring to FIGS. 2A and 2B, the LED 130 will be described in more detail below. The LED 130 includes a substrate 131, a first lead terminal 132, a second lead terminal 133, an LED chip 134, a lens 135, and a wire 136. The first and second lead terminals 132 and 133 are formed on the substrate 131. The LED chip 134 is mounted onto the first lead terminal 132 and connected to the second lead terminal 133 through the wire 136. The lens 135 includes a base 135a for encapsulating the LED chip 134 and fixing the first and second lead terminals 132 and 133, and a protrusion 135b, having a second shape, is formed to protrude in a semicircular shape to increase a light output angle. The base 135a and protrusion 135b of the lens 135 are preferably integrally formed. The lens 135 may be composed of transparent resin such as epoxy or silicon resin. Although one LED chip may be used, embodiments of the present invention are not limited thereto, and a plurality of chips may be mounted on the substrate. In addition, the protrusion is not limited to a semicircular shape, but various shapes capable of increasing a light output angle may be used.

The LEDs 130 is mounted to the LED flexible PCB 140, and the LEDs 130 mounted on the LED flexible PCB 140 are arranged at one side of the light guide plate 190. Grooves 195 of a predetermined shape, a first shape, are formed in the end or edge of light guide plate 190, and one or more of the LEDs 130 are partially inserted and arranged in the grooves 195 at regular intervals, respectively. In this manner, the first shape and the second shape correspond to each other, and are adapted to mate together. Specifically, the semicircular groove shape 195 (first shape) is adapted to receive the corresponding semicircular protrusion shape 135b (second shape) so that opposing surfaces engage. While semicircular grooves and protrusions are shown, other shapes may also be used. Although four LEDs 130 are mounted on the LED flexible PCB 140 as shown, the number of LEDs is not limited thereto. That is, the number of LEDs may be greater or fewer than the number shown.

Now, referring to FIG. 2C, an arrangement of the light guide plate and the LEDs will be described in more detail. The light guide plate 190 serves to change a light generated from the LEDs 130 into a light having an optical distribution in a surface light source shape. The grooves 195 having a predetermined shape are formed in an end of the light guide plate 190 in correspondence to the number and positions of the LEDs 130. That is, the four grooves 195, each of which has a semicircular shape corresponding to the shape of the protrusion 135b of the LED lens, are formed in the end of the light guide plate 190 at regular intervals in correspondence to the positions of the LEDs. The number, positions and shapes of the grooves 195 are not limited thereto, but may be changed in various ways.

As described above, the portion of the LED lens, i.e., the protrusion 135b, is inserted and arranged in the groove 195 formed in the end of the light guide plate 190. The light guide plate 190 may be composed of a polymethyl-methacrylate (PMMA) resin or PLEXIGLAS (R), and may be made into a cut sheet by extrusion molding or into a sheet by injection molding. On the rear surface of the light guide plate, a light-scattering printing pattern may be formed using paint in order to uniformly emit an incident light from the LED to any positions. Also, a diffusion pattern for diffusing light on the light guide pattern may be formed on the rear surface of the light guide plate to obtain irregular light reflection. In addition, the light guide plate 190 may be formed to have a slant end as shown in FIG. 2C, or in a variety of shapes such as a parallel flat plate shape. Although it has been illustrated where the LEDs are arranged only in one side of the light guide plate, embodiments of the present invention are not limited thereto. That is, the LEDs may be arranged in two or more sides of the light guide plate.

Referring to FIGS. 1 and 3, the first reflection plate 150, the plurality of optical sheets 170 and 180 and the second reflection plate 210 will be described in more detail. The first reflection plate 150 is arranged on an upper surface of the flexible PCB on which the LEDs 130 are mounted. At this time, one end of the first reflection plate 150 is arranged to cover a portion of the upper surface of the light guide plate 190 and upper surfaces of the LEDs 130. Here, the first reflection plate 150 is preferably composed of or includes a plastic material, for example white polyethylene terephthalate (PET). Since the first reflection plate 150 is directly affected by heat emitted from the LEDs 130, the white PET having a predetermined reflectivity is suitable for preventing the reflection plate from being deteriorated by the heat.

As described above, if the upper surfaces of the LED lenses 135 are covered with the first reflection plate 150, the light emitted upward from the LED lenses 135 is reflected downward or toward the incident surface of the light guide plate, whereby it is possible to prevent light loss. The second reflection plate 210 is arranged below the light guide plate 190. As for the second reflection plate 210, a plate with a high light reflectivity is used, and it is installed to be in contact with a floor surface of a bottom chassis (not shown). In addition, an end or extension portion of the second reflection plate 210 extends to cover the lower surfaces of the LEDs 130. Since the lower surfaces of the LEDs 130 are covered with the second reflection plate 210, the light emitted downward from the LEDs 130 may be reflected upward or toward the incident surface of the light guide plate, whereby it is possible to prevent the light loss. Further, the end of the second reflection plate (i.e. the portion in contact with the LEDs 130) may be formed of white PET with a predetermined reflectivity in order to prevent the deterioration of the reflection plate caused from the heat emitted from the LEDs 130.

The diffusion plate 180 and the two prism sheets 170 are disposed over the light guide plate 190. The light passing through the upper surface of the light guide plate 190 includes not only a light emitted perpendicularly to the upper surface but also lights emitted to be inclined at a variety of angles, so that the diffusion plate 180 diffuses the incident light from the light guide plate 190 to prevent the light from being locally concentrated. The prism sheet 170 may include a first prism sheet and a second prism sheet. The first and second prism sheets are formed so that triangular prisms are respectively formed on their upper surfaces in a predetermined pattern and then arranged to cross with each other. Thus, the prism sheet 170 serves to concentrate the light diffused in the diffusion plate 180 to be perpendicular to the LCD panel (not shown). Although the two prism sheets are shown, the present invention is not limited thereto, and only one prism sheet may be used to concentrate the light.

As described above, an LED having a lens is arranged to a side of the light guide plate having the groove formed thereon, and the first and second reflection plates are arranged to cover the upper and lower surfaces of the LED lens, so that it is possible to minimize the loss of the light emitted from the LED. In addition, since white PET is used for the reflection plates to prevent deterioration caused by the heat of the LED, it is possible to prevent a decrease in brightness over time due to the deterioration of the reflection plates.

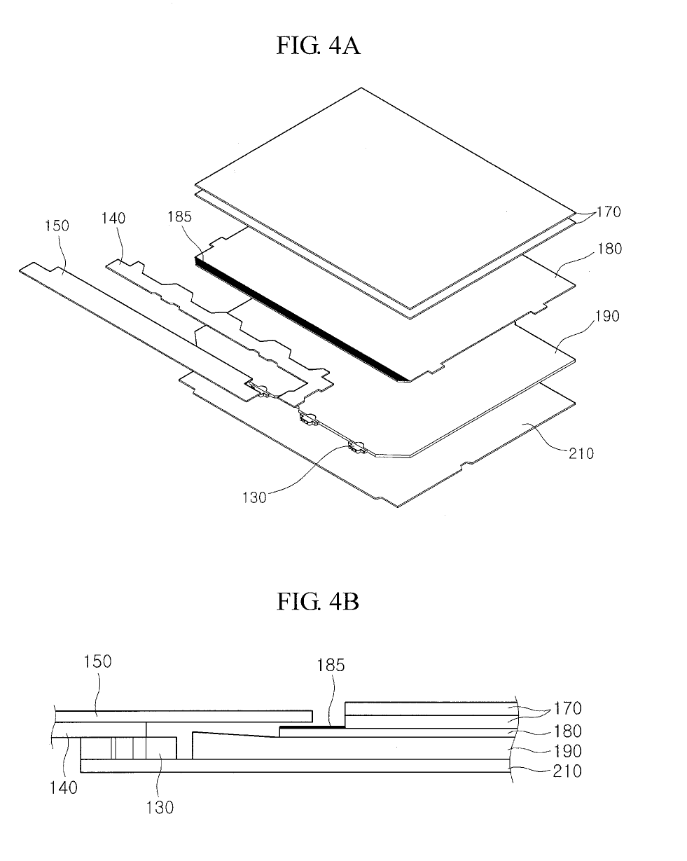

FIGS. 4A and 4B are a partial exploded perspective view and a sectional view showing a backlight unit according to a second embodiment of the present invention. The configuration of the second embodiment shown in FIGS. 4A and 4B is substantially similar to those of the first embodiment, except that a light blocking layer is additionally formed, so that the following descriptions will be focused on such differences. Referring to FIGS. 4A and 4B, the backlight unit according to the second embodiment of the present invention includes LEDs 130, an LED flexible PCB 140, a first reflection plate 150, a plurality of optical sheets 170 and 180, a light guide plate 190 and a second reflection plate 210.

The first reflection plate 150 is arranged on an upper surface of the flexible PCB on which the LEDs 130 are mounted. At this time, one end of the first reflection plate 150 is arranged to cover a portion of the upper surface of the light guide plate 190 and upper surfaces of the LEDs 130. The second reflection plate 210 is arranged below the light guide plate 190. As the second reflection plate 210, a plate with a high light reflectivity is used, and it is installed to be in contact with a floor surface of a bottom chassis (not shown). In addition, an end of the second reflection plate 210 extends to the LEDs 130. That is, the end of the second reflection plate 210 extends to cover lower surfaces of the LEDs 130. The diffusion plate 180 and the two prism sheets 170 are subsequently laminated and disposed over the light guide plate 190. The light passing through the upper surface of the light guide plate 190 includes not only light emitted perpendicularly to the upper surface but also light emitted and inclined at a variety of angles, so that the diffusion plate 180 diffuses the incident light from the light guide plate 190 to prevent the light from being locally concentrated.

A light blocking layer 185, configured to block light leaking upward or toward the LCD panel through the LEDs 130, is formed at one end of the diffusion plate 180 (i.e., its end adjacent to the LEDs 130). The light blocking layer 185 is printed on the diffusion plate 180 with a black ink by silk printing or the like. As described above, the light blocking layer 185 formed at the end of the diffusion plate 180 prevents light, which is not reflected by the first reflection plate 150, from being irradiated toward the LED, thereby solving a so-called street light shortcoming or inferiority as viewed from the external appearance of the LCD panel (i.e., a hot spot problem by which portions where the LEDs are arranged are seen or visible through the LCD panel). Although black ink is used to form the light blocking layer by printing in this embodiment, the present invention is not limited thereto but a variety of methods may be used for forming the light blocking layer.

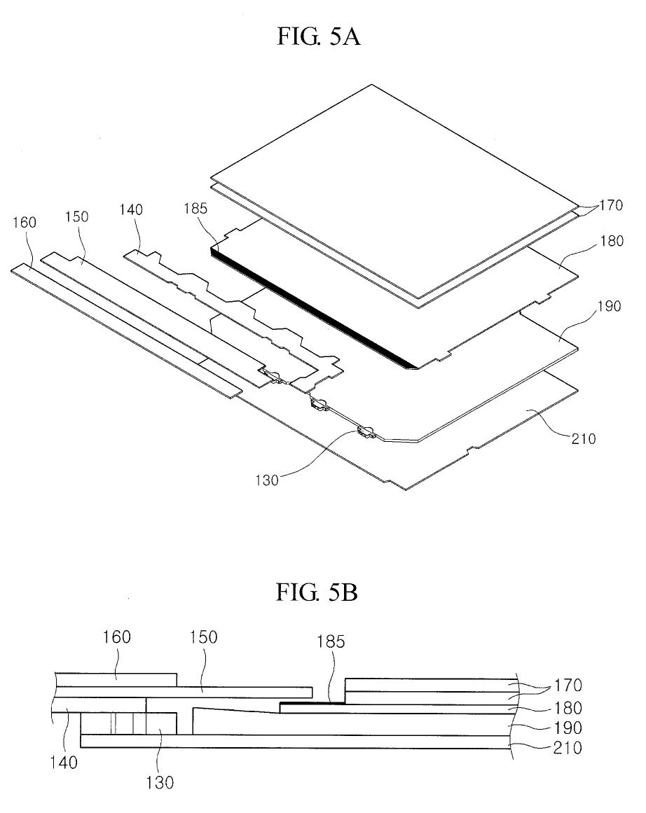

FIGS. 5A and 5B are a partial exploded perspective view and a sectional view showing a backlight unit according to a third embodiment of the present invention. The configurations of the third embodiment shown in FIGS. 5A and 5B are substantially similar to those of the second embodiment, except that a pressing member is further included, so that the following descriptions will be focused on such differences. The backlight unit according to the third embodiment of the present invention includes LEDs 130, an LED flexible PCB 140, a first reflection plate 150, a pressing member 160, a plurality of optical sheets 170 and 180, a light guide plate 190 and a second reflection plate 210. The first reflection plate 150 is arranged on an upper surface of the flexible PCB on which the LEDs 130 are mounted. One end of the first reflection plate 150 is arranged to cover a portion of the upper surface of the light guide plate 190 and upper surfaces of LED lenses 135. The pressing member 160 is arranged on the first reflection plate to press against the first reflection plate 150. The pressing member 160 is preferably formed in a shape corresponding to the first reflection plate 150. As described above, if the pressing member 160 is arranged on the first reflection plate 150 to press the first reflection plate 150, one end of the first reflection plate 150 is bent downward. Thus, a gap between one end of the light guide plate 190 and the first reflection plate 150 is substantially eliminated. Accordingly, it is possible to block light leaking through the above gap, thereby further decreasing light loss and preventing deterioration of the appearance.

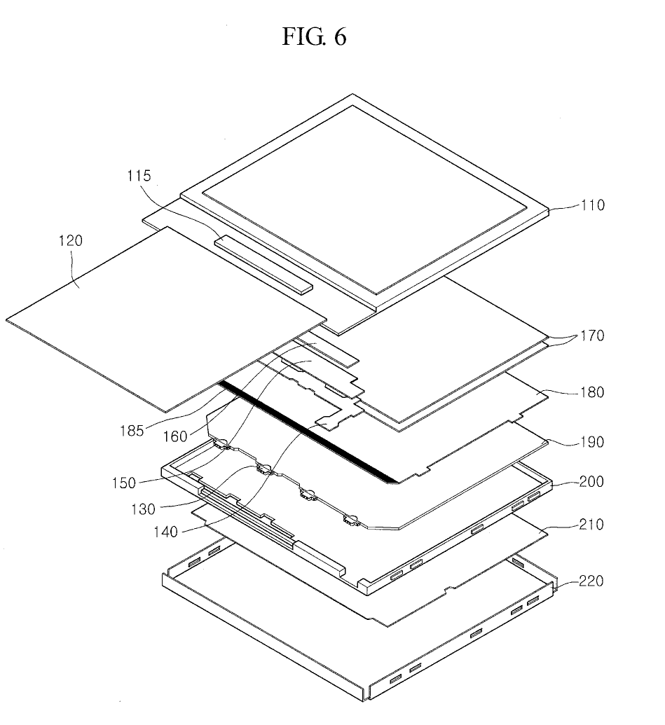

FIG. 6 is an exploded perspective view showing a light crystal display having the backlight unit according to an embodiment of the present invention. Referring to FIG. 6, the LCD includes an LCD panel 110, an LCD driving IC 115, a main flexible PCB 120, LEDs 130, an LED flexible PCB 140, a first reflection plate 150, a pressing member 160, prism sheets 170, a diffusion plate 180, a light guide plate 190, a molded frame 200, a second reflection plate 210 and a bottom chassis 220.

The LCD panel 110 includes a color filter substrate, a thin film transistor (TFT) substrate, and a liquid crystal layer injected between the color filter substrate and the TFT filter. The color filter substrate is formed with a red-green-blue (RGB) color filter that is a color pixel where a predetermined color is revealed when a light passes through it. The color filter substrate includes a black matrix, the RGB color filter and an overcoat film. The front surface of the overcoat film is coated with a common electrode composed of a transparent conductor material such as indium tin oxide (ITO) or indium zinc oxide (IZO). The TFT substrate is a transparent glass substrate on which TFTs are formed in a matrix form. Data lines are connected to source terminals of the TFTs, and gate lines are connected to gate terminals. In addition, pixel electrodes including transparent electrodes composed of a transparent conductive material are formed at drain terminals. If an electric signal is applied to the data and gate lines, each TFT is turned on or off to apply an electric signal required for forming a pixel of the drain terminal. When power is applied to the gate and source terminals of the TFT substrate to turn on the TFT, an electric field is formed between the pixel electrode and the common electrode of the color filter substrate. Thus, the arrangement of the liquid crystal injected between the TFT substrate and the color filter substrate is changed, and light transmissivity is also changed according to the changed arrangement of the liquid crystal, thereby obtaining a desired image.

The LCD driving IC 115 is connected to the LCD panel 110, and applies predetermined gate and data signals to the gate and data lines of the TFT substrate, respectively. The main flexible PCB 120 is electrically connected to the LCD panel 110 and the LCD driving IC 115. The main flexible PCB 120 is mounted with a timing controller for generating an electric signal to control a variety of circuit parts such as a gate driver IC and a source driver IC and controlling a digital data signal input from a computer or the like, a direct-current to direct-current (DC-DC) converter circuit for generating different kinds of voltages, and a gamma standard voltage generator for outputting a voltage in a gray scale of the source driver IC. The LCDs 130 are mounted on the LED flexible PCB 140, and arranged to one side of the light guide plate 190. Grooves of a predetermined shape are formed in the light guide plate 190, and the LEDs 130 are partially inserted and arranged in the grooves.

The first reflection plate 150 is arranged on an upper surface of the flexible PCB 140 on which the LEDs 130 are mounted. At this time, one end of the first reflection plate 150 is arranged to cover a portion of the upper surface of the light guide plate 190 and upper surfaces of the LEDs 130. The second reflection plate 210 is arranged below the light guide plate 190, and at this time one end of the second reflection plate 210 extends to the LEDs 130. If the first and second reflection plates 150 and 210 are used to cover the upper and lower surfaces of the LEDs 130 as described above, light loss emitted above and below the LED lenses 135 can be prevented. The pressing member 160 may be arranged on the first reflection plate to press against the first reflection plate 150, and a light blocking layer 185 may be formed on one end of the diffusion plate 180. The mold frame 200 has a predetermined receiving space formed therein, and the LEDs 130, the light guide plate 190, the diffusion plate 180, the plurality of prism sheets 170 and so on are received in the receiving space in the mold frame. The bottom chassis 220 is installed below the mold frame 200, and then coupled with the mold frame 200.

According to one or more embodiments of the present invention as described above, an LED having a projected lens of a predetermined shape is arranged in a corresponding groove formed in a light guide plate, thereby increasing the quantity of light applied to the light guide plate and thus decreasing the number of LEDs that must be used for a backlight. In addition, reflection plates are formed above and below the lenses of the LEDs, whereby it is possible to minimize loss of the light leaking upward or downward from the LED lenses. Moreover, deterioration of the reflection plates is reduced to prevent lowering of brightness as time goes and to ensure greater reliability. Further, a light blocking layer is additionally formed on the diffusion plate, or a pressing member is arranged to press the reflection plate, thereby improving uniformity of the light emitted through the light guide plate, addressing inferiorities or imperfections in external appearance.

The aforementioned descriptions are merely exemplary embodiments of the LCD according to the present invention, and the scope of the invention should be understood to include various changes and modifications made by those skilled in the art without departing from the spirit of the present invention, as defined in the appended claims, not limited to the above embodiments.

What is claimed is:

1. A backlight unit, comprising:
a light guide plate having a groove with a first shape formed in at least one side thereof;
at least one light emitting diode (LED) having a projected lens, the LED being arranged in correspondence to the groove of the light guide plate;
a first reflection plate arranged over the LED; and
a second reflection plate arranged below the LED.

2. The backlight unit of claim 1, further comprising a flexible printed circuit board (FPCB) for mounting the LED thereon, wherein the first reflection plate is arranged on the FPCB to cover a portion of an upper surface of the light guide plate and an upper surface of the lens of the LED.

3. The backlight unit of claim 1, wherein the first reflection plate includes white polyethylene terephthalate (PET).

4. The backlight unit of claim 1, wherein the second reflection plate is arranged below the light guide plate, and at least one end of the second reflection plate extends to the LED.

5. The backlight unit of claim 1, further comprising a plurality of optical sheets arranged over the light guide plate, wherein a light blocking layer configured to block light emitted from the LED is formed on at least one end of at least one of the plurality of optical sheets.

6. The backlight unit of claim 5, wherein the plurality of optical sheets include a diffusion plate arranged on the light guide plate, and at least one prism sheet arranged on the diffusion plate, wherein the light blocking layer is formed on at least one end of the diffusion plate.

7. The backlight unit of claim 5, wherein the light blocking layer and the first reflection plate are partially overlapped with each other.

8. The backlight unit of claim 1, further comprising a pressing member arranged on the first reflection plate, the pressing member being configured to press against the first reflection plate.

9. The backlight unit of claim 1, wherein the LED includes a substrate, at least one LED chip mounted on the substrate, and a LED lens encapsulating the LED chip, wherein the LED lens comprises a base formed on the substrate, the LED lens including a protrusion formed to protrude from the base in a second shape.

10. The backlight unit of claim 9, wherein the first shape groove of the light guide plate is adapted to mate with the second shape protrusion of the LED lens.

11. The backlight unit of claim 9, wherein the first shape is a semicircular groove and the second shape is a corresponding semicircular protrusion.

12. A liquid crystal display, the liquid crystal display comprising:
a backlight unit, the backlight unit comprising:
a light guide plate having a groove with a first shape formed in at least one side thereof,
at least one light emitting diode (LED) having a projected lens, the LED being arranged in correspondence to the groove of the light guide plate;
a first reflection plate arranged adjacent to an LED first surface; and
a second reflection plate arranged adjacent to an LED second surface, the second surface being substantially parallel to the first surface.

13. The liquid crystal display of claim 12, wherein the backlight unit further comprises a flexible printed circuit board (FPCB) for mounting the LED thereon, wherein the first reflection plate is arranged on the FPCB to cover a portion of an upper surface of the light guide plate and an upper surface of the lens of the LED.

14. The liquid crystal display of claim 12, wherein the first reflection plate includes white polyethylene terephthalate (PET).

15. The liquid crystal display of claim 12, wherein the second reflection plate is arranged below the light guide plate, and at least one end of the second reflection plate extends to the LED.

16. The liquid crystal display of claim 12, wherein the backlight unit further comprises a plurality of optical sheets arranged over the light guide plate, wherein a light blocking layer configured to block light emitted from the LED is formed on at least one end of at least one of the plurality of optical sheets.

17. The liquid crystal display of claim 16, wherein the plurality of optical sheets include a diffusion plate arranged on the light guide plate, and at least one prism sheet arranged on the diffusion plate, wherein the light blocking layer is formed on at least one end of the diffusion plate.

18. The liquid crystal display of claim 16, wherein the light blocking layer and the first reflection plate are partially overlapped with each other.

19. The liquid crystal display of claim 12, wherein the backlight unit further comprises a pressing member arranged on the first reflection plate, the pressing member being configured to press against the first reflection plate.

20. The liquid crystal display of claim 12, wherein the LED includes a substrate, at least one LED chip mounted on the substrate, and a LED lens encapsulating the LED chip, wherein the LED lens comprises a base formed on the substrate, the LED lens including a protrusion formed to protrude from the base in a second shape, the first shape groove of the light guide plate being adapted to mate with the second shape protrusion of the LED lens, the first shape being a semicircular groove and the second shape being a corresponding semicircular protrision.
